(19) United States
(12) Patent Application Publication
(10) Pub. No.: US 2024/0087050 A1
(43) Pub. Date: Mar. 14, 2024

(54) DIGITAL WAGE STATEMENT SYSTEM AND METHOD

(71) Applicants: Melissa L. Raines, East Syracuse, NY (US); Maria C. Donnelly, East Syracuse, NY (US); Joseph C. Pagano, Southington, CT (US); Lisa A. Volles, Syracuse, NY (US)

(72) Inventors: Melissa L. Raines, East Syracuse, NY (US); Maria C. Donnelly, East Syracuse, NY (US); Joseph C. Pagano, Southington, CT (US); Lisa A. Volles, Syracuse, NY (US)

(21) Appl. No.: 17/943,676

(22) Filed: Sep. 13, 2022

(51) Int. Cl. G06Q 40/00; G06Q 10/10; G06Q 40/08

(52) U.S. Cl. CPC G06Q 40/125; G06Q 10/1057; G06Q 40/08

(57) ABSTRACT

According to some embodiments, an input device may receive wage statement information via a web portal, including jurisdiction information associated with an injury. A computer system may then ingest third-party data associated with an insured. An indication of a pay period frequency may be received from the insured along with an indication of an initial pay period begin date via the web portal. A series of pay period begin date and pay period end date fields may then be automatically pre-populated based on the jurisdiction, the third-party data, the pay period frequency, and initial pay period begin date. Wage values associated with a plurality of the pay period begin date and pay period end date fields may be received from the insured, and an electronic wage statement file may be generated based on the received wage values.

### BACKGROUND

In some cases, an insured may be entitled to receive insurance benefits based at least in part on past wages that he or she has earned. For example, an injured worker might receive workers' compensation payments from an insurance company based on his or her average weekly wages over the prior year. To submit information about past wages to an insurance company, an insured or an employer might provide copies of old paychecks, screenshots taken from a payroll accounting system, and/or information manually entered by hand on an insurance form. A claim handler associated with the insurance company might then review the wage information and determine an appropriate benefit amount. Such a determination, however, can be difficult to perform in an accurate and consistent manner. For example, extended periods away from work, bonuses, and overtime pay may need to be accounted for by the claim handler. Moreover, the appropriate way to handle these situations can vary depending on the jurisdiction in which an injury occurred (e.g., different states might have different workers' compensation laws and regulations).

Individual jurisdictions have generated required paper forms on which information regarding the injured worker, including past wage information, must be submitted. The forms vary among jurisdictions as to format and required information. In addition to average weekly wage information, individual state forms may require display of such information as gross earnings and other earnings. Calculations of these values may vary among jurisdictions, depending, for example, on rules governing rates for overtime and double time. These values are in turn employed in calculation of average weekly wage values. Errors in these values may result in rejection of filings of required forms.

As a result of variations in rules from jurisdiction to jurisdiction, required information and underlying formulas need to vary from jurisdiction to jurisdiction. Individual claim handlers and employer human resource departments may be responsible for injured workers in multiple jurisdictions. It would be desirable for capabilities for calculations and generation of suitable forms in multiple jurisdictions to be available without a need for separate application programs or for large programs that require extensive storage, transmission and memory resources.

A wide variety of options may be available for determination of pay periods. For example, different employers may use weekly, bi-weekly, monthly, semi-monthly and other pay periods. Accurate determinations of past pay period begin and end dates may be difficult as a result.

Note that penalties may be applied to an insurance company that fails to determine benefits in an accurate and consistent manner. For example, a state auditor might assess penalties, including interest penalties, when an insurance company fails to determine and/or document workers' compensation cases in an appropriate manner. Moreover, note that problems might arise from inconsistent and/or inaccurate wage statement data provided by an injured worker or an employer, inconsistent and/or inaccurate benefit calculations by a claim handler, or insufficient documentation about the benefit calculations in a claim file.

Systems and methods for improvements in processes relating to workers' compensation claims, including greater accuracy in determinations, while avoiding unnecessary burdens on computer processing resources, would be desirable.

### SUMMARY OF THE INVENTION

According to some embodiments, systems, methods, apparatus, computer program code and means may provide ways to facilitate generation of an electronic wage statement file. An input device may receive wage statement information via a web portal, including jurisdiction information associated with an injury. A computer system may then ingest third-party data associated with an insured. An indication of a pay period frequency may be received from the insured along with an indication of an initial pay period begin date via the web portal. A series of pay period begin date and pay period end date fields may then be automatically pre-populated based on the jurisdiction, the third-party data, the pay period frequency, and initial pay period begin date. Wage values associated with a plurality of the pay period begin date and pay period end date fields may be received from the insured, and an electronic wage statement file may be generated based on the received wage values.

Some embodiments provide means for receiving wage statement information via a web portal, including a jurisdiction associated with an injury; means for ingesting, by a computer processor, third-party data associated with an insured from a remote server; means for receiving from the insured an indication of a pay period frequency via the web portal; means for receiving from the insured an indication of an initial pay period begin date via the web portal; means for automatically pre-populating by the computer processor a series of pay period begin date and pay period end date fields based on the jurisdiction associated with the injury, the third-party data, the pay period frequency, and initial pay period begin date; means for receiving from the insured wage values associated with a plurality of the pay period begin date and pay period end date fields; means for automatically generating by the computer processor the electronic wage statement file based on the received wage values; and means for storing the electronic wage statement file in a data storage device.

A technical effect of some embodiments of the invention is an improved and computerized method of generating an electronic wage statement file. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of an insurance computing system according to some embodiments of the present invention.

FIG. 2 is block diagram of a system according to some embodiments of the present invention.

FIG. 3 illustrates a method according to some embodiments of the present invention.

FIGS. 4 through 12 illustrate contract of hire logic and displays in accordance with some embodiments.

FIGS. 13 through 22 illustrate injured worker wage logic and displays according to some embodiments.

FIG. 23 is block diagram of a wage statement platform in accordance with some embodiments of the present invention.

FIG. 24 is a tabular portion of a wage statement database according to some embodiments.

FIG. 25 illustrates a display in accordance with some embodiments described herein.

FIG. 26 shows a block diagram of interrelated tables in a spreadsheet implemented embodiment.

FIG. 27 shows a flow diagram of a method in accordance with some embodiments.

FIG. 28 shows a system diagram with data flows according to some embodiments.

### DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data availability, consistency, and analytics associated with a digital wage statement calculator. The present invention is directed to more than merely a computer implementation of a routine or conventional activity previously known in the industry as it provides a specific advancement in the area of electronic record availability, consistency, and analysis by providing improvements in the operation of a computer system that uses machine learning and/or predictive models to ensure data quality. The present invention provides improvement beyond a mere generic computer implementation as it involves the novel ordered combination of system elements and processes to provide improvements in the speed at which such data can be made available and consistent results. Some embodiments of the present invention are directed to a system adapted to automatically validate information, analyze electronic records, aggregate data from multiple sources including text mining, determine appropriate wage information, etc. Moreover, communication links and messages may be automatically established (e.g., to provide wage information reports and alerts), aggregated, formatted, exchanged, etc. to improve network performance (e.g., by reducing an amount of network messaging bandwidth and/or storage required to support wage information collection and distribution).

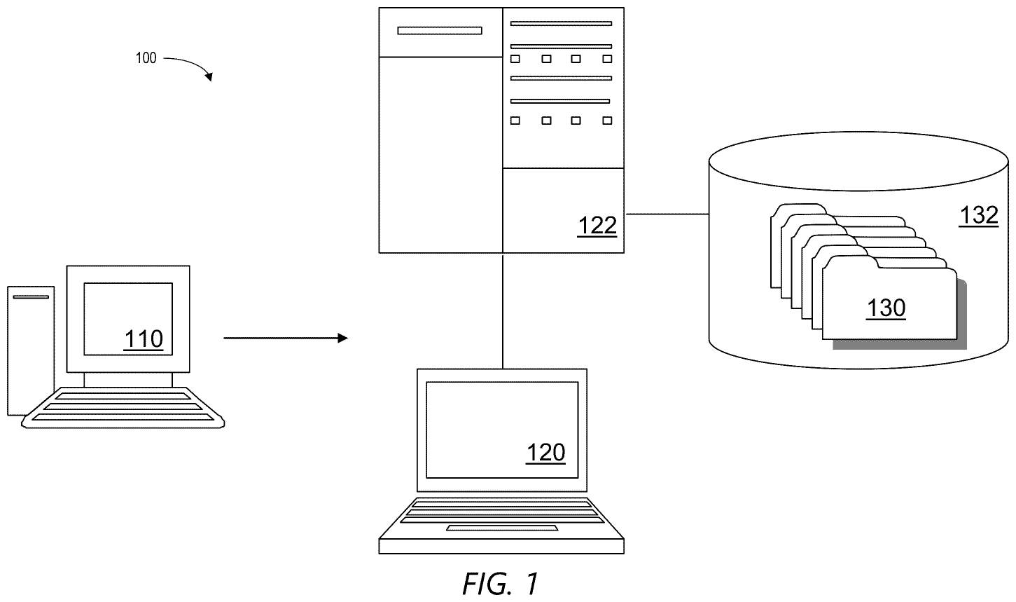

FIG. 1 is block diagram of an insurance computing system 100 according to some embodiments of the present invention. In particular, an insured associated with an insured computing device 110 (e.g., a desktop computer, laptop computer, tablet computer, etc.) may be entitled to receive insurance benefits based at least in part on past wages that he or she has earned. For example, an injured worker might receive workers' compensation payments from an insurance company based on his or her average weekly wages over the prior year. To submit information about past wages to an insurance company, the insured computing device 110 might be used to provide copies of old paychecks, screenshots taken from a payroll accounting system, and/or information manually entered by hand on an insurance form. A claim handler computing device 120 associated with the insurance company might then be used to review the wage information, determine an appropriate benefit amount, and document his or her determination in a claim file 130 stored at a remote storage device 132 (e.g., via an intermediate insurance processing platform 122). Such a determination, however, can be difficult to perform in an accurate and consistent manner. For example, extended periods away from work, bonuses, and overtime pay may need to be accounted for by the claim handler. Moreover, the appropriate way to handle these situations can vary depending on the jurisdiction in which an injury occurred

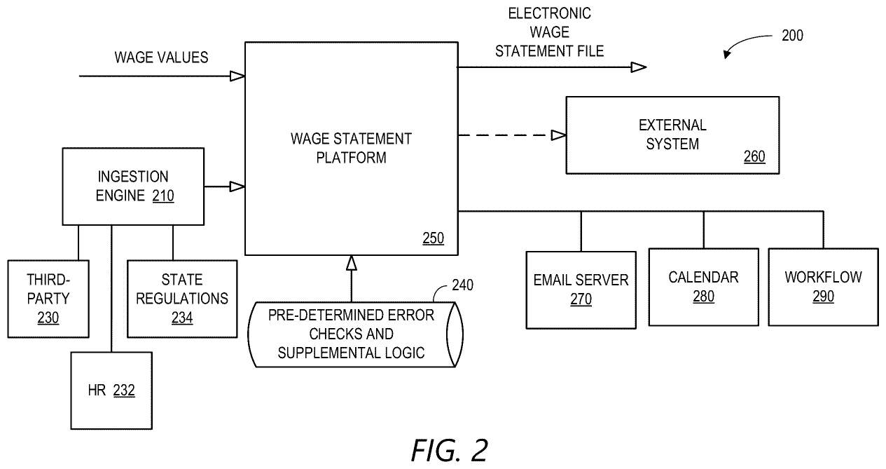

It would therefore be desirable to provide systems and methods to facilitate the workflow in an automated, efficient, and accurate manner. FIG. 2 is block diagram of a system 200 according to some embodiments of the present invention. In particular, the system 200 includes a wage statement platform 250 that receives wage values (e.g., from an insured). The wage statement platform 250 might be, for example, associated with a Personal Computers (“PC”), laptop computer, an enterprise server, a web server farm, and/or a database or similar storage devices. The wage statement platform 250 may, according to some embodiments, be associated with an insured, a business organization, or an insurance provider. In some embodiments, the wage statement platform 250 also receives third-party information 230 (e.g., information about prescription drug benefits provided via a pharmacy, driving milage reimbursement data, etc.), Human Resources (“HR”) information (e.g., payroll data) 232, and/or state regulation information 234 via an ingestion engine 210.

In some embodiments, the state regulation information 234 may be automatically updated on a periodic basis (e.g., yearly, quarterly, monthly, etc.). Moreover over, the state regulation information 234 might be automatically retrieved from government servers, be analyzed using Artificial Intelligence (“AI”) processing, be based on a subscription or messaging model, and/or be manually initiated. According to some embodiments, the ingestion engine 210 and/or other elements of the system 200 may utilize an intelligent chatbot application (e.g., using Natural Language Processing (“NLP”)) or a conversational Interactive Voice Response (“IVR”) system to interact with the user and obtain relevant wage information (e.g., similar to the ALEXA® system used by AMAZON® and the SIRI® system used by APPLE®).

According to some embodiments, an “automated” wage statement platform 250 may facilitate generation of an electronic wage statement file. As used herein, the term “automated” may refer to, for example, actions that can be performed with little or no human intervention. The wage statement platform may, for example, help insureds submit appropriate wages, assist claim handlers to adjust submitted wages as warranted, and/or facilitate an automatic generation and/or posting of consistent and accurate file notes.

As used herein, devices, including those associated with the wage statement platform 250 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The wage statement platform 250 may also access pre-determined error checks and supplemental logic 240. The pre-determined error checks and supplemental logic 240 might be associated with, for example, state laws and regulations. The pre-determined error checks and supplemental logic 240 may be locally stored or reside remote from the wage statement platform 250. As will be described further below, the pre-determined error checks and supplemental logic 240 may be used by the wage statement platform 250 along with the wage values to generate an accurate electronic wage statement file. According to some embodiments, the wage statement platform 250 communicates with an external system 260, such as by transmitting electronic wage statement information to an insurance provider platform, an email server 270 (e.g., to automatically establish a communication link with a claim handler based on wage statement information), a calendar application 280 (e.g., to automatically create a reminder for a claim handler or an employee based on wage statement information), a workflow management system 290, etc.

Although a single wage statement platform 250 is shown in FIG. 2, any number of such devices may be included. Moreover, various devices described herein might be combined according to embodiments of the present invention. For example, in some embodiments, the wage statement platform 250 and pre-determined error checks and supplemental logic 240 might be co-located and/or may comprise a single apparatus.

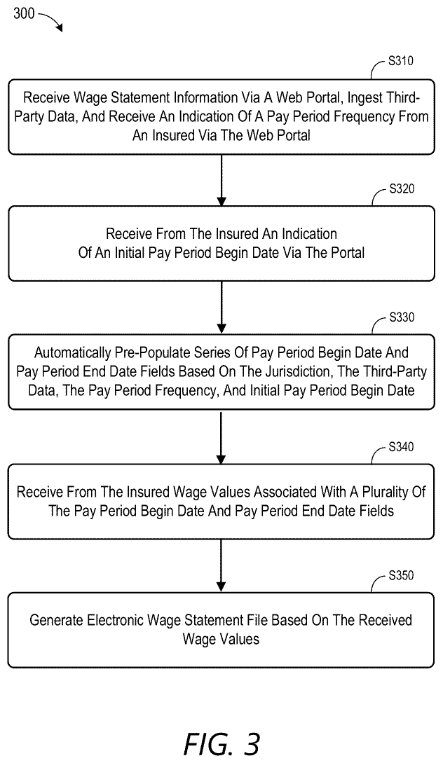

FIG. 3 illustrates a method that might be performed, for example, by some or all of the elements of the system 200 described with respect to FIG. 2 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, an input device may receive wage statement information via a portal (e.g., from a manager), including a jurisdiction associated with an injury (a state in which the insured was injured). For example, the insured might enter information into a web portal that uses an authentication process (e.g., incorporating two-factor authentication, a one-time password, etc.). In some embodiments, the system is implemented using web “microsites.” As used herein, the term “microsites” may refer to an individual web page or a relatively small cluster of pages which are meant to function as a discrete entity within an existing website or to complement an offline activity. According to some embodiments, the wage statement information may include an indication of a pay period frequency, such as an indication that the insured was paid on a monthly, bi-weekly, or weekly basis. According to some embodiments, the wage statement information and/or other information described herein may be received from another party associated with the insured (e.g., a family member or intermediate claim service). Other examples of wage statement information that might be received from the insured include: (i) an employee name, (ii) a claim number, (iii) a date of loss (e.g., associated with when an accident occurred or when a claim was submitted), (iv) a date of hire, (v) period of employment information, and/or (vi) date of completion information (e.g., indicating when the insured provided the wage statement information). At S310, the system may also ingest third-party data and receive (via the portal) an indication of a pay period frequency.

At S320, an indication of an initial pay period begin date may be received from the insured. For example, the insured might indicate that he or she began working for a company on Jul. 15, 2024. At S330, a series of pay period begin date and pay period end date fields may be automatically pre-populated based on jurisdiction associated with the injury, the third-party data, the pay period frequency, and the initial pay period begin date. For example, cells in a wage table might be automatically populated with dates reflecting 52 weeks of bi-weekly pay periods.

At S340, wage values associated with a plurality of the pay period begin date and pay period end date fields may be received from the insured. For example, the insured might enter into the wage table some or all of the following information for each pay period: (i) a number of regular hours worked, (ii) a number of overtime hours worked, (iii) an hourly rate, and (iv) other wages.

At S350, an electronic wage statement file may be generated based on the received wage values. For example, the web portal might automatically compute a gross wages amount for each of the plurality of pay period begin date and pay period end date fields based on the wage values. Moreover, an average weekly wage amount might be automatically computed and documented for the electronic wage statement file. The average weekly wage amount can then be used to determine an appropriate benefit amount for the insured (e.g., in accordance with a workers' compensation rule engine). According to some embodiments, an automatically generated electronic wage statement file is associated with one of a plurality of potential jurisdictions and the workers' compensation rule engine computes the average weekly wage amount based on at least one of a minimum value and a maximum value applicable to that jurisdiction.

Moreover, in some embodiments a wage increase is automatically and retroactively applied to prior pay periods in accordance with appropriate jurisdiction logic. In addition, the system may automatically perform one or more error checks on the wage statement information received from the insured in accordance with a pre-determined error checking rule. In some embodiments, the system may dynamically determine and display supplemental data based on wage statement information received from the insured. The wage statement information received from the insured further might include, for example, an employee name, a claim number, a date of loss, a date of hire, period of employment information, date of completion information, etc. In some embodiments, the system may automatically generate an insurance claim file note associated with the electronic wage statement file including information about a proposed benefit rate calculation.

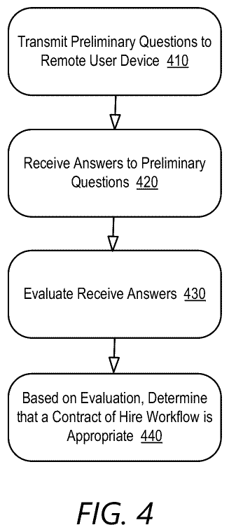

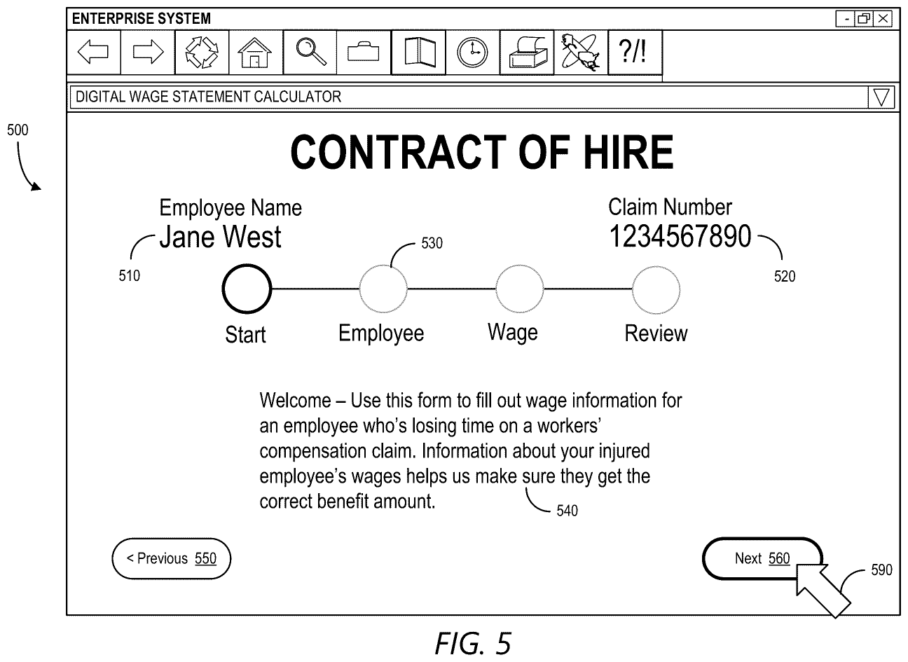

According to some embodiments, an insured might use a graphical user interface to provide wage information. For example, FIGS. 4 through 12 illustrate contract of hire logic and displays in accordance with some embodiments. In particular, FIG. 4 shows contract of hire logic according to some embodiments. Initially the system may transmit preliminary questions to a remote user device 410 (e.g., asking for a date of hire, date of loss, etc.). Answers to the preliminary questions are received 420 and evaluated 430. Based on the evaluation, it may be determined that a contract for hire workflow is appropriate which results in a contract of hire start display 500 as illustrated in FIG. 5. The contract of hire start display 500 includes an employee name 510 and a claim number 520. The display also includes a graphical navigation progress bar 530 along with some introductory instructions 540, a “Previous” icon 550 and a “Next” icon 560.

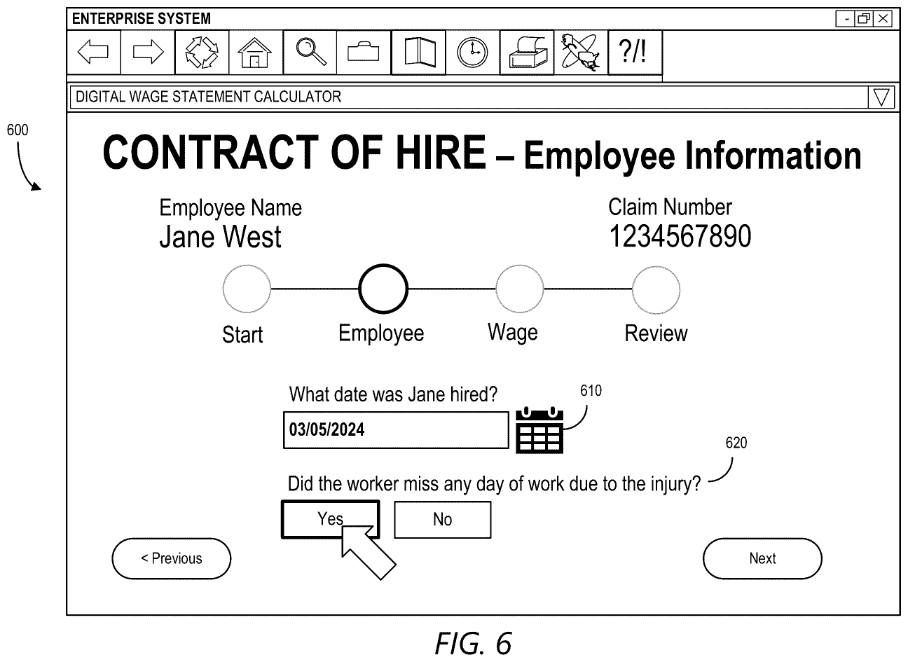

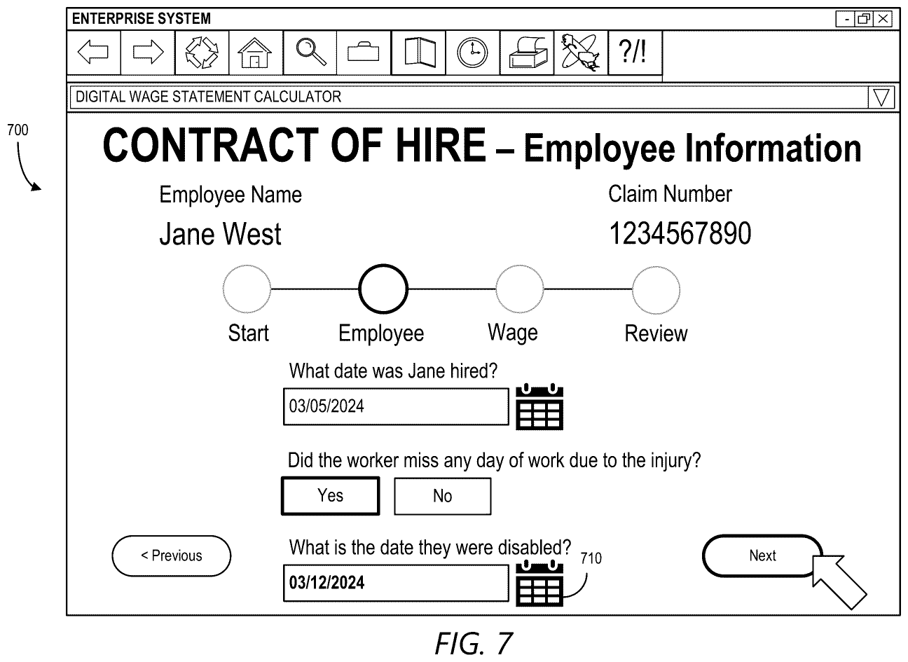

Selection of the “Next” icon 560 (e.g., via touchscreen or computer mouse pointer 590) results in a contract of hire employee information display 600 as illustrated in FIG. 6. The contract of hire employee information display 600 includes entry areas where a user can enter a date of hire 610 along with an indication of whether the employee missed any day of work due to the injury 620. If the user indicates that the employee missed a day of work due to the injury 620 (e.g., selecting a “Yes” icon), a new data entry area appears where the user can supply the date the employee became disabled 710 as shown by the display 700 of FIG. 7.

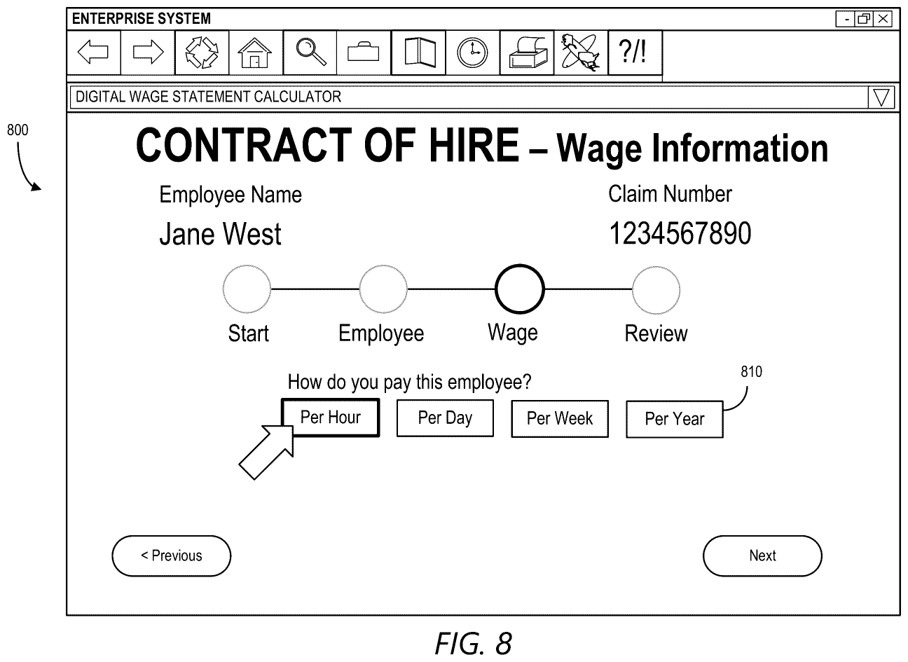

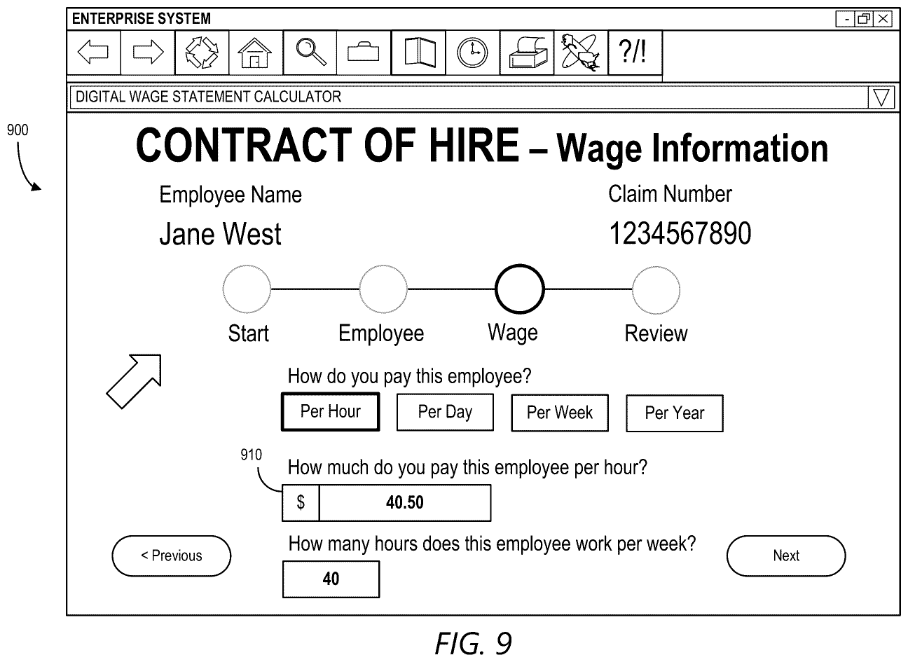

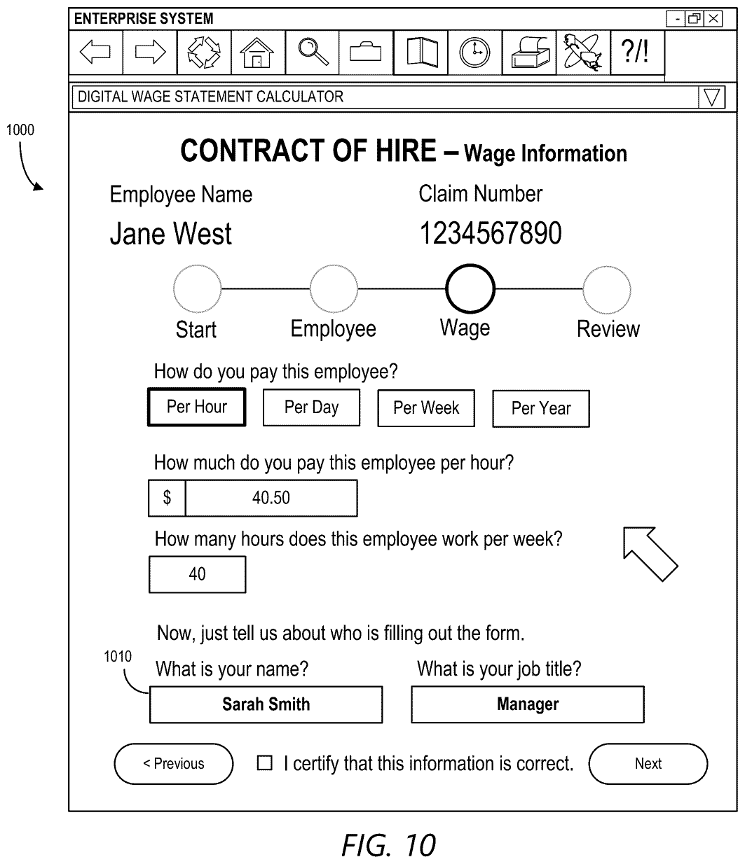

Selection of a “Next” icon results in a contract of hire wage information display 800 such as the one shown in FIG. 8. The display 800 includes a data entry area where a user can indicate an applicable pay period 810 (e.g., hourly, monthly, per day, per week, per year, etc.). When a pay period is indicated, additional questions 910 are added to a contract of hire wage information display 900 as shown in FIG. 9 in accordance with appropriate state requirements (e.g., to enter how much the employee is paid per hour and how many hours the employee works per week). After this information is entered, additional questions 1010 are added to a contract of hire wage information display 1000 as shown in FIG. 10 (e.g., to enter the name and job title of the person providing the wage information).

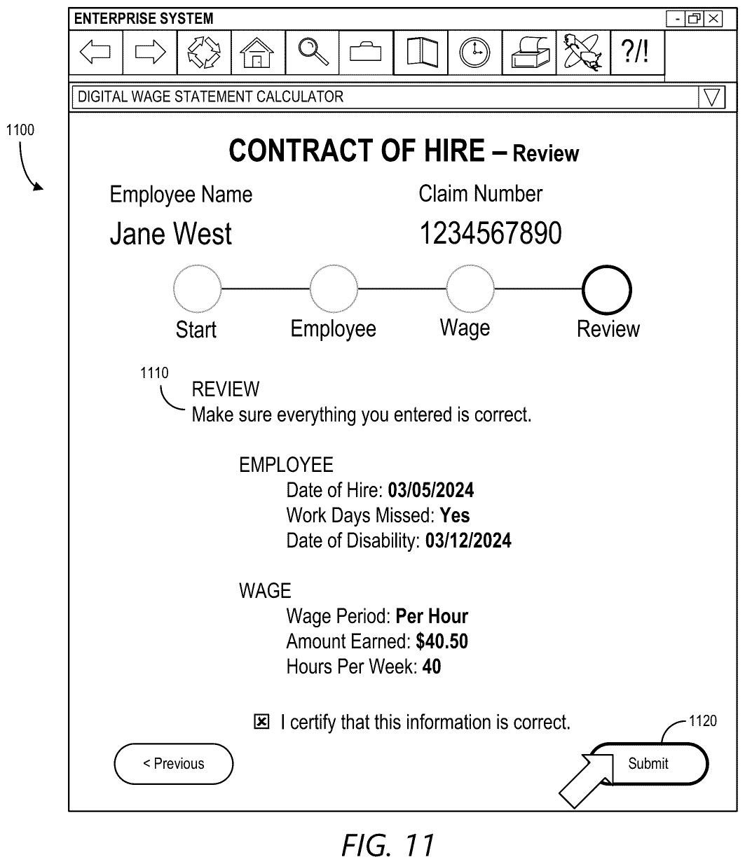

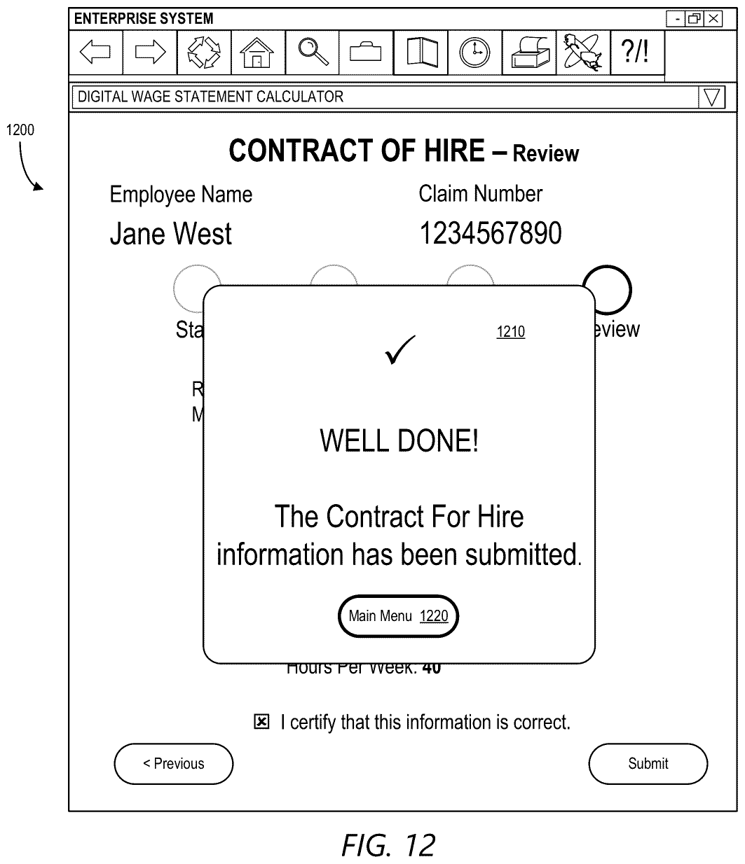

A contract of hire review display 1100 as shown in FIG. 11 is then provided to the user. The review display 1100 includes a summary 1110 of the information that was previously entered (e.g., the employee and wage data) along with a certification stating that the summary 1110 is correct (if not, the user can select a “Previous” icon and change the information). Selection of a “Submit” icon 1120 completes the contract of hire process. A popup window 1210 on a contract of hire display 1200 lets the user know that the information has been submitted as shown in FIG. 12.

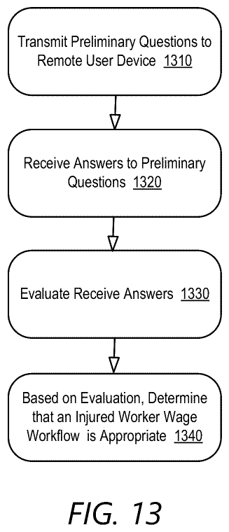

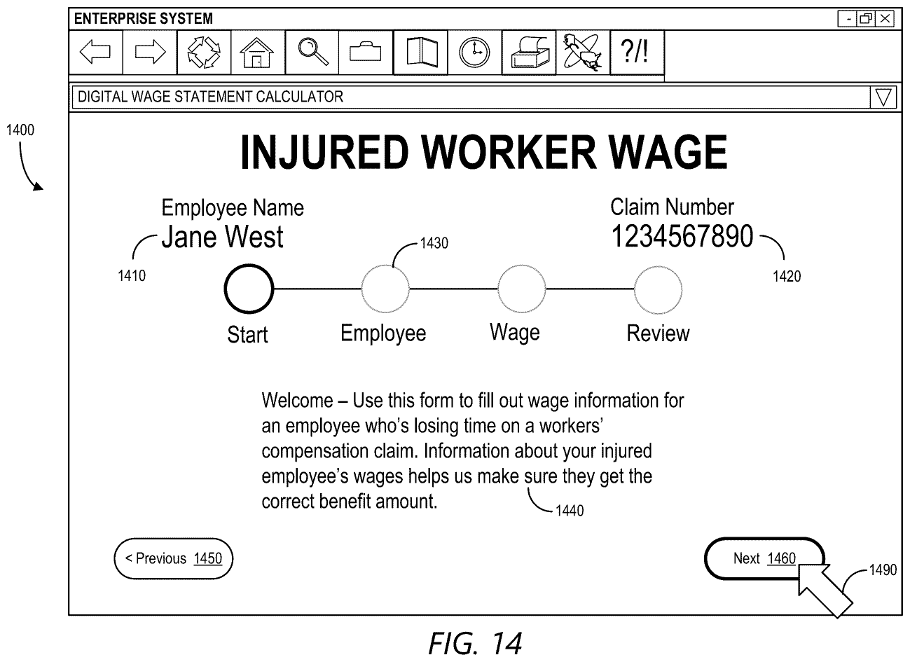

Selection of a “Main Menu” icon 1220 may return the user to a main menu display (note that FIGS. 13 through 22 illustrate injured worker wage logic and displays according to some embodiments). As shown in FIG. 13, initially the system may transmit preliminary questions to a remote user device 1310 (e.g., asking for a date of hire, date of loss, etc.). Answers to the preliminary questions are received 1320 and evaluated 1330. Based on the evaluation, it may be determined that an injured worker wage workflow is appropriate which results in an injured worker wage start display 1400 as illustrated in FIG. 14. The injured worker wage start display 1400 includes an employee name 1410 and a claim number 1420 (e.g., a workers' compensation insurance claim number). The display also includes a graphical navigation progress bar 1430 along with some introductory instructions 1440, a “Previous” icon 1450 and a “Next” icon 1460.

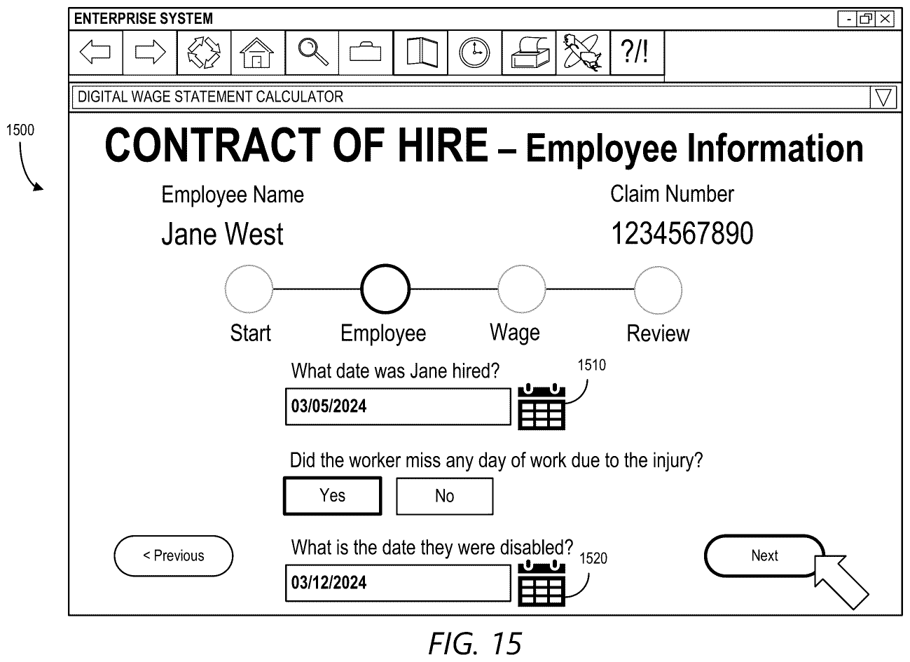

Selection of the “Next” icon 1460 (e.g., via touchscreen or computer mouse pointer 1490) results in an injured worker wage employee information display 1500 as illustrated in FIG. 15. The injured worker wage employee information display 1500 includes entry areas where a user can enter a date of hire 1510 along with an indication of whether the employee missed any day of work due to the injury. If the user indicates that the employee missed a day of work due to the injury (e.g., selecting a “Yes” icon), a data entry area appears where the user can supply the date the employee became disabled 1520.

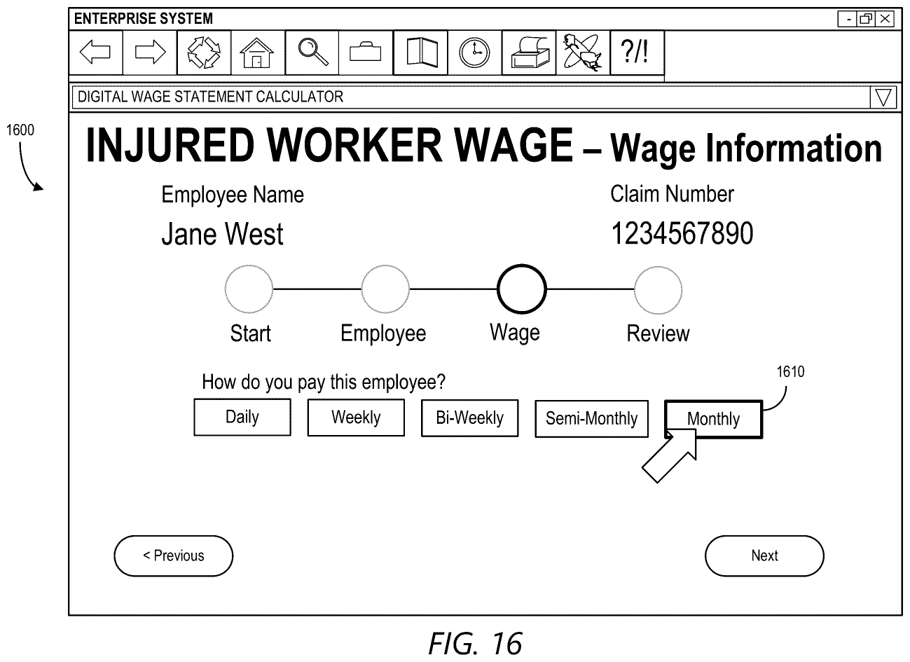

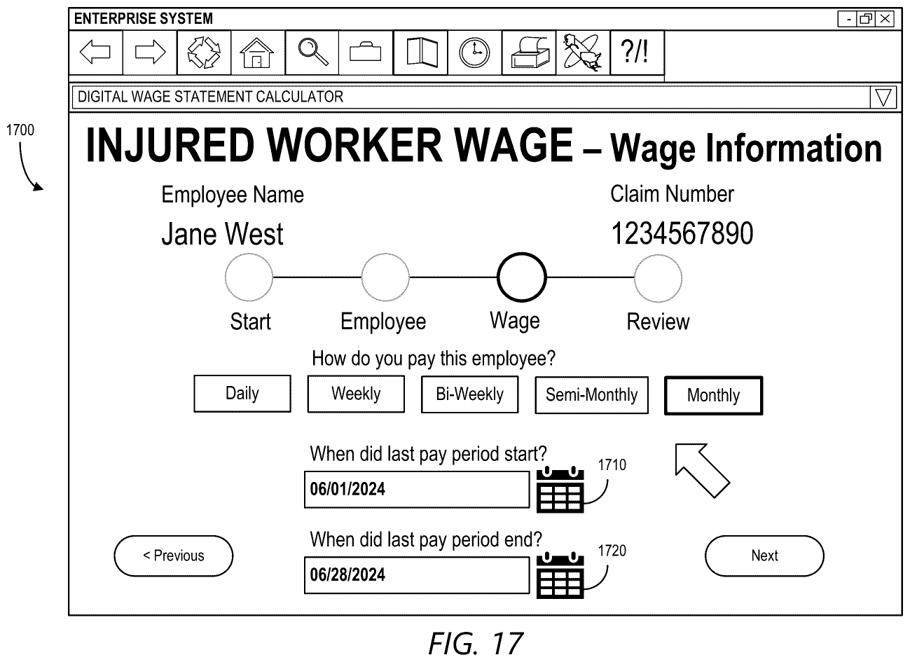

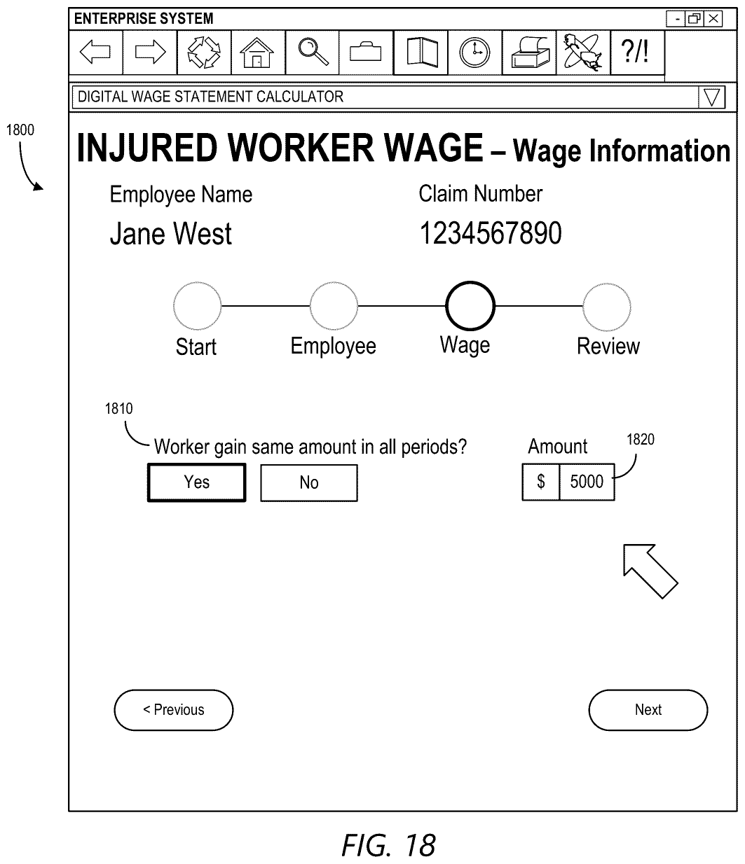

Selection of a “Next” icon results in an injured worker wage information display 800 such as the one shown in FIG. 16. The display 1600 includes a data entry area where a user can indicate an applicable pay period 1610 (e.g., daily, weekly, bi-weekly, semi-monthly, monthly, etc.). When a pay period is indicated, additional questions 1710, 1720 are added to an injured worker wage information display 1700 as shown in FIG. 17 in accordance with appropriate state requirements (e.g., to enter when the employee's last pay period started 1710 and ended 1720). After this information is entered, additional questions 1810, 1820 are added to an injured worker wage information display 1800 as shown in FIG. 18 (e.g., to indicate if the worker gained the same amount in all pay periods 1810 along with a monetary value of the amount of gain 1820).

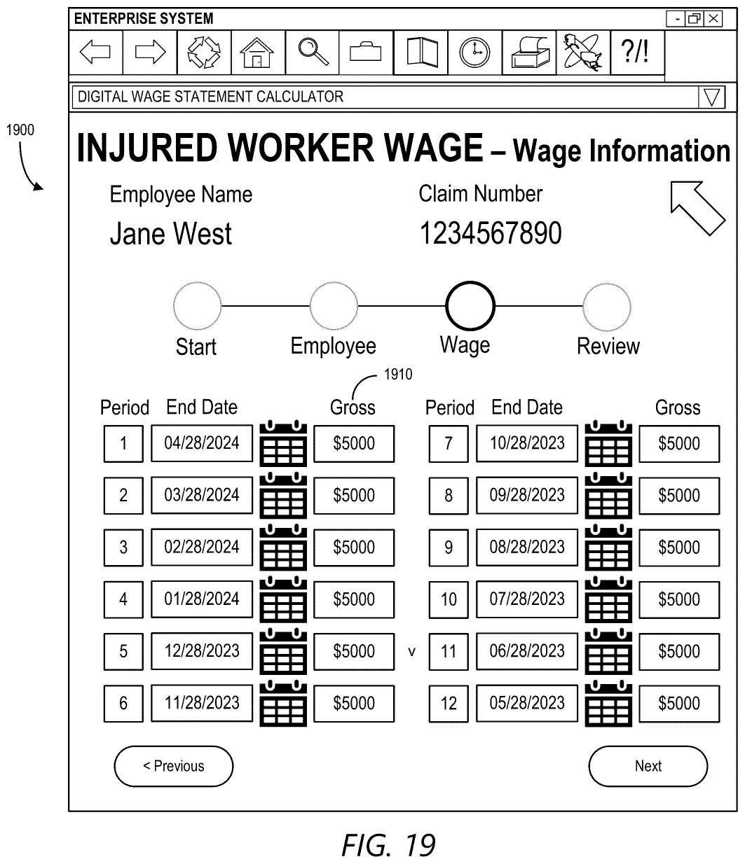

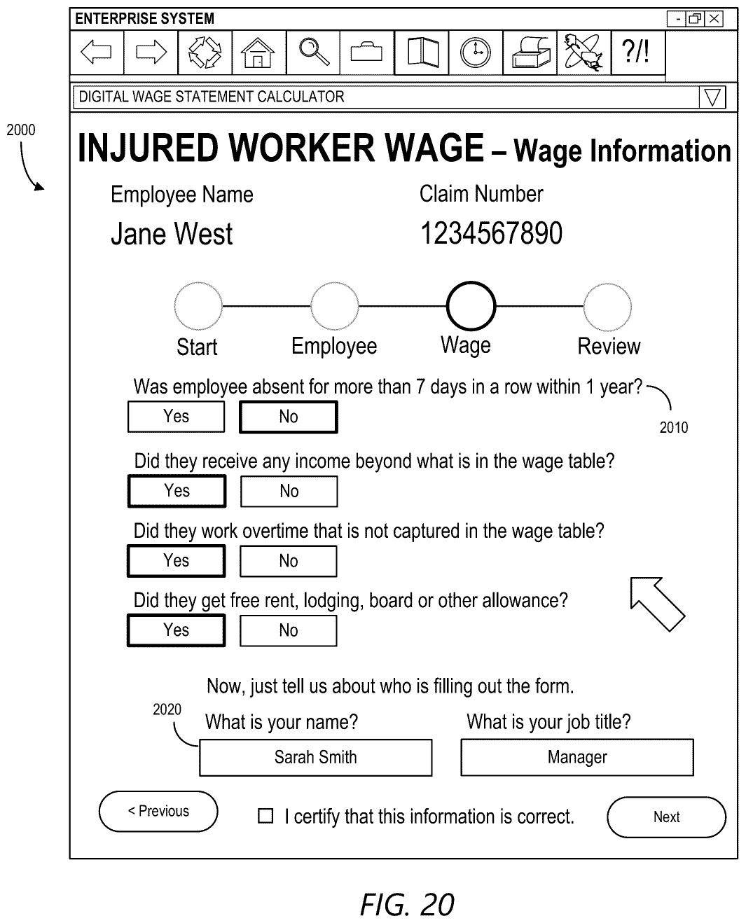

After this information is provided, a wage table 1910 is provided on an injured worker wage information display 1900 as shown in FIG. 19. The wage table 1910 includes, for each of a plurality of pay periods (e.g., periods “1” through “12”), an end date and a gross pay amount for that pay period. Next, an injured worker wage information display 2000 as shown in FIG. 20 is used to answer a dynamically generated series of questions (e.g., based on state law). Examples of such questions include:
Was the employee absent for more than seven days in a row?
Did the employee receive other income?
Did the employee work overtime?
Did the employee get free ledging, board, or other allowances?
   The injured worker wage information display 2000 may also be used to enter the name and job title 2020 of the person providing the wage information.

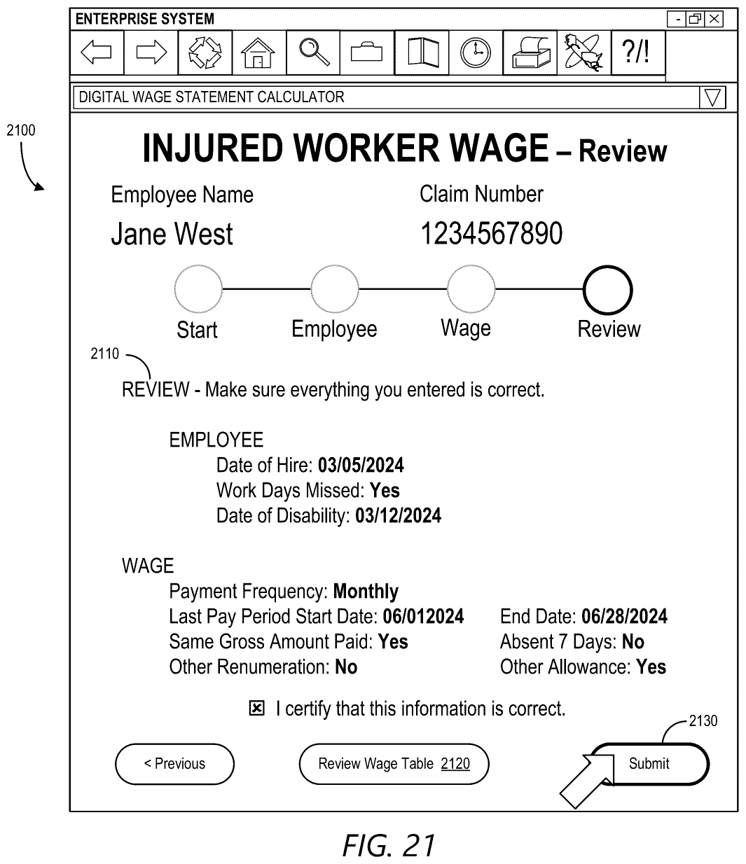

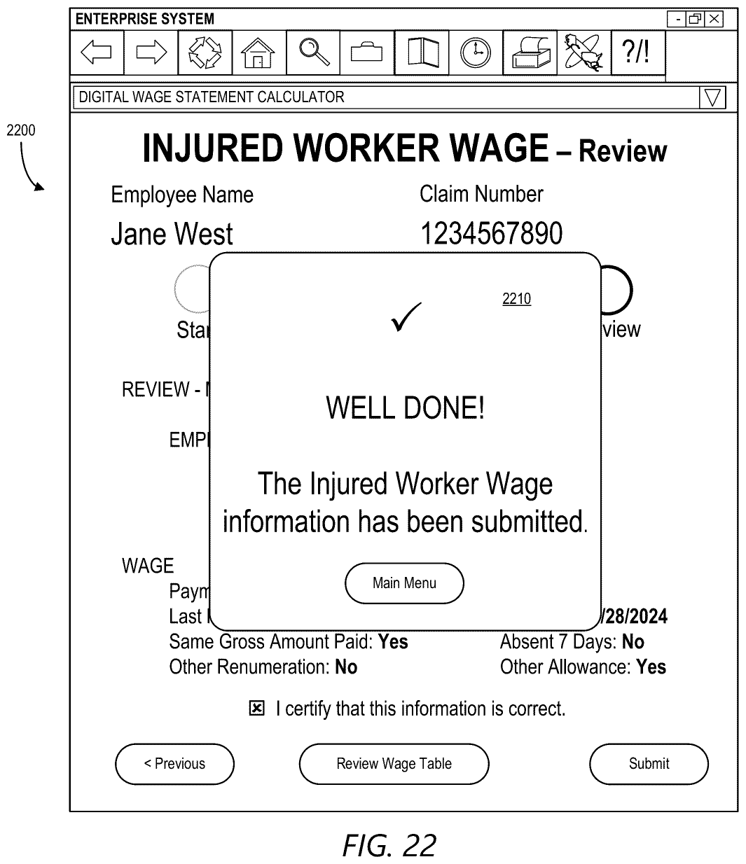

An injured worker wage review display 2100 as shown in FIG. 21 is then provided to the user. The review display 2100 includes a summary 2110 of the information that was previously entered along (e.g., the employee and wage data) with a certification stating that the summary 2110 is correct (if not, the user can select a “Previous” icon and change the information). A “Review Wage Table” icon 2120 lets the user access and verify the pay period wage information. Selection of a “Submit” icon 2130 completes the injured worker wage process. A popup window 2210 on an injured worker wage display 2200 lets the user know that the information has been submitted as shown in FIG. 22.

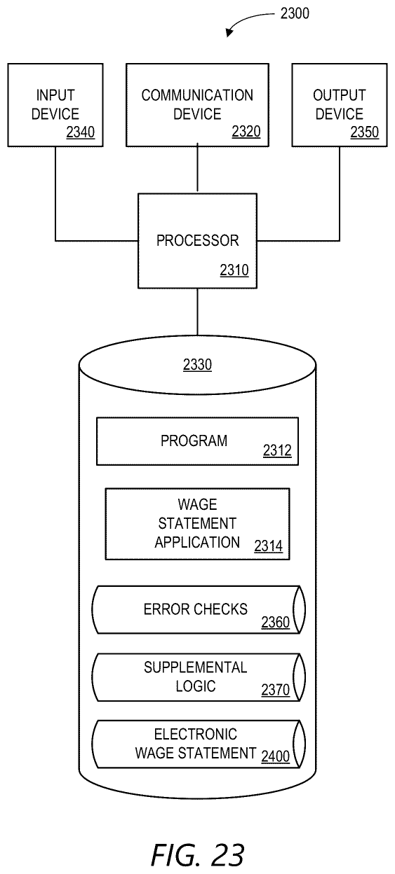

The embodiments described herein may be implemented using any number of different hardware configurations. For example, FIG. 23 illustrates a wage statement platform 2300 that may be, for example, associated with the system 200 of FIG. 2. The wage statement platform 2300 comprises a processor 2310, such as one or more commercially available Central Processing Units (“CPUs”) in the form of one-chip microprocessors, coupled to a communication device 2320 configured to communicate via a communication network (not shown in FIG. 23). The communication device 2320 may be used to communicate, for example, with one or more remote devices. The wage statement platform 2300 further includes an input device 2340 (e.g., a mouse and/or keyboard to enter wage information or adjustments) and an output device 2350 (e.g., a computer monitor to display a wage statement and/or claim file note).

The processor 2310 also communicates with a storage device 2330. The storage device 2330 may comprise any appropriate information storage device, including combinations of magnetic storage devices (e.g., a hard disk drive), optical storage devices, mobile telephones, and/or semiconductor memory devices. The storage device 2330 stores a program 2312 and/or a wage statement application 2314 (e.g., associated with a spreadsheet application and/or plug-in) for controlling the processor 2310. The processor 2310 performs instructions of the programs 2312, 2314, and thereby operates in accordance with any of the embodiments described herein. For example, the input device 2340 may receive wage statement information via a web portal, including jurisdiction information associated with an injury. The processor 2310 may then ingest third-party data associated with an insured. An indication of a pay period frequency may be received from the insured along with an indication of an initial pay period begin date via the web portal. A series of pay period begin date and pay period end date fields may then be automatically pre-populated by the processor 2310 based on the jurisdiction, the third-party data, the pay period frequency, and initial pay period begin date. Wage values associated with a plurality of the pay period begin date and pay period end date fields may be received from the insured, and an electronic wage statement file may be generated by the processor 2310 based on the received wage values.

The programs 2312, 2314 may be stored in a compressed, uncompiled and/or encrypted format. The programs 2312, 2314 may furthermore include other program elements, such as an operating system, a database management system, and/or device drivers used by the processor 2310 to interface with peripheral devices.

As used herein, information may be “received” by or “transmitted” to, for example: (i) the wage statement platform 2300 from another device; or (ii) a software application or module within the wage statement platform 2300 from another software application, module, or any other source.

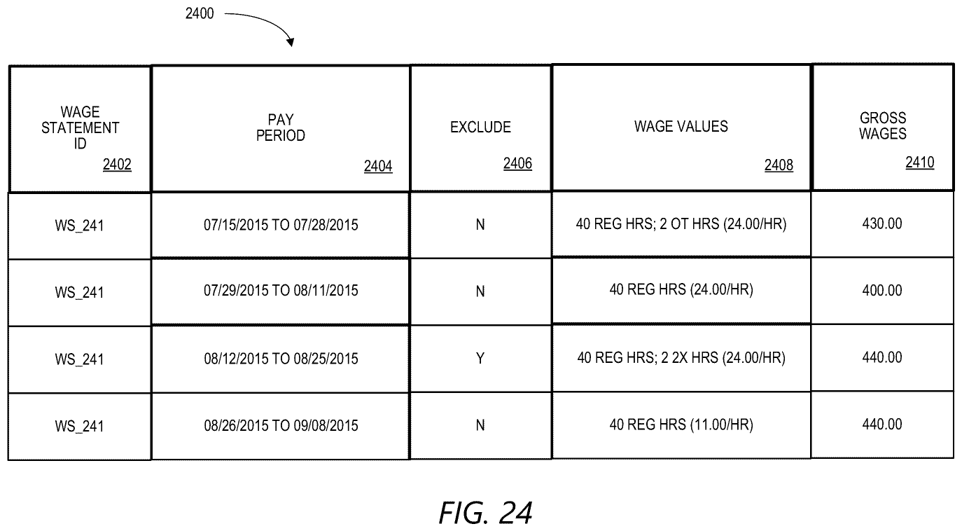

In some embodiments (such as shown in FIG. 23), the storage device 2330 stores an error check database 2360 (e.g., with rules to help detect potentially inaccurate information), a supplemental logic database 2370 (e.g., incorporating context-based rules to provide hints or supplemental questions for an insured), and an electronic wage statement database 2400. An example of a database that may be used in connection with the wage statement platform 2300 will now be described in detail with respect to FIG. 24. Note that the database described herein is only one example, and additional and/or different information may be stored therein. Moreover, various databases might be split or combined in accordance with any of the embodiments described herein.

Referring to FIG. 24, a table is shown that represents the electronic wage statement database 2400 that may be stored at the wage statement platform 2300 according to some embodiments. The table may include, for example, entries identifying pay periods for which an insured is providing wage information. The table may also define fields 2402, 2404, 2406, 2408, 2410 for each of the entries. The fields 2402, 2404, 2406, 2408, 2410, may, according to some embodiments, specify: a wage statement identifier 2402, a pay period 2404, an exclude indication 2406, wage values 2408, and gross wages 2410. The information in the electronic wage statement database 2400 may be created and updated, for example, based on information received from an insured or claim handler.

The wage statement identifier 2402 may be, for example, a unique alphanumeric code identifying a particular wage statement being submitted by an insured in connection with an insurance claim. The pay period 2404 might be automatically populated by a wage statement platform based on a pay period frequency and initial pay period begin date provided by an insured. The indication of exclusion 2406 might indicate, for example, whether a claim handler has decided that a particular pay period should (or should not) be included in a benefit calculation. The wage values 2408 may be provided by the insured and include, for example, numbers of hours worked and an hourly rate of pay. The gross wages 2410 might be automatically calculated by the wage statement platform and may be used, for example, to determine an appropriate average weekly wage for the insured.

Thus, some embodiments may provide improved benefit calculations and reduce financial inaccuracies (and associated penalties, including accrued interest). In addition, the electronic wage statement files may be transparent and limit areas of confusion for auditors.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

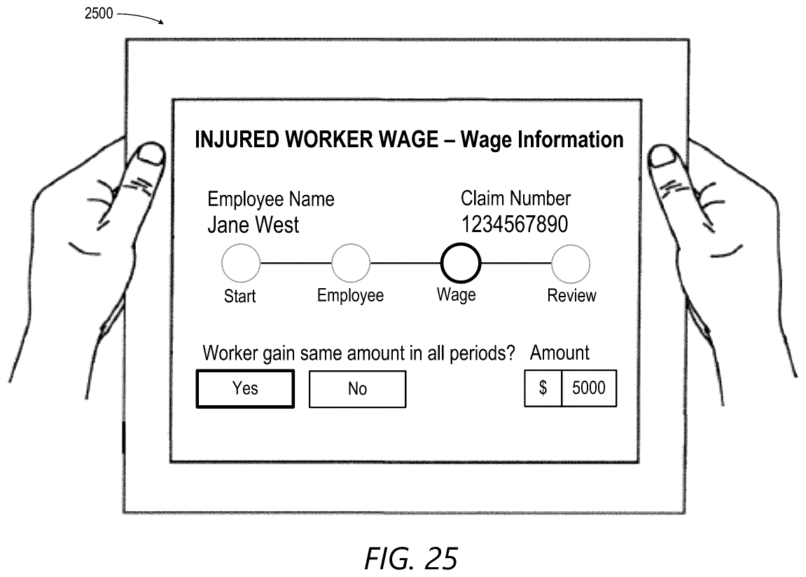

Moreover, some embodiments have been described herein as being accessed via a PC or laptop computer. Note, however, that embodiments may be implemented using any device capable of executing the disclosed functions and steps. For example, FIG. 25 illustrates a display 2500 in accordance with some embodiments described herein. In particular, the display 2500 includes a graphical user interface including information about injured worker wage information displayed via a tablet computer or smartphone in accordance with any of the embodiments described herein.

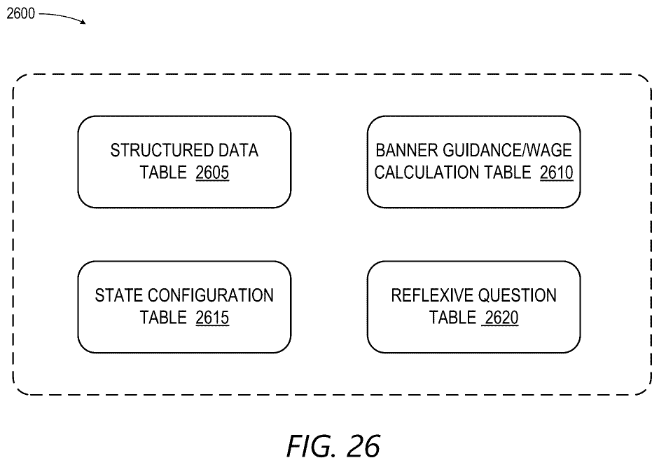

Referring to FIG. 26, a diagram is shown of interrelated tables 2600 in a spreadsheet implemented embodiment. Structured data table 2605, banner guidance and Average Weekly Wage (“AWW”) calculation table 2610, state configuration table 2615 and reflexive question table 2620 are shown. Structured data table 2605 includes data arranged by state, such as units, such as weeks or days, employed in calculations, threshold data, categories of hours worked employed in a calculation, and other data. Banner guidance/AWW calculation table 2610 provides display order for banner text and stores calculation results. State configuration table 2615 provides state rules and display controls arranged by state. Reflexive question table 2620 includes question text and rules for reflexive questions required for each state. The tables include references to cells in one another, thereby facilitating use of rules and calculations set forth in multiple tables in connection with generation of user interface displays and calculations of values. The interrelated tables 2600 may be used, for example, to support an enterprise or insurer web portal.

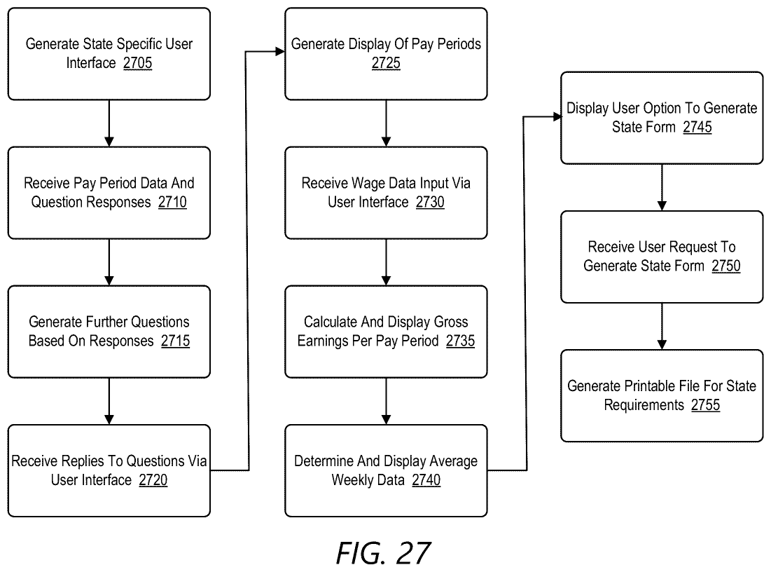

Referring to FIG. 27, a process flow diagram of a process performed, such as by system 200, is shown. The system may dynamically generate 2705 a user interface with fields for input specific to a particular jurisdiction. The input fields may include fields for input of pay period data, such as frequency (such as by selection of weekly, bi-weekly, semi-monthly or enter manually from a drop-down menu) and begin and end dates, and inputs for fields of responses to reflexive questions. The system then automatically generates or receives 2710 the pay period data and responses to reflexive questions via the user interface. Based on the responses, the system may generate 2715 further questions for display along with response fields for questions, in accordance with instructions embodied, for example, in a reflexive question table. The system may then receive 2720 replies to the further questions via the user interface. The system may then generate 2725 a display of pay periods with suitable pay period data fields for each pay period. The pay period determination may be based on application of state specific rules, such as whether a date of loss may be after the last pay period stop date, or other rules, by way of example. The data fields may be determined based on state rules and replies to reflexive questions. The fields may include fields for such data as scheduled days paid, gross earnings, hourly rate, regular hours, overtime hours, double time hours, mileage reimbursed, tips and other wages, by way of example. The system may then receive 2730 wage data input in the displayed fields, such as in response to a user selection of a displayed command button, labeled, e.g., “calculate,” on the user interface. The system on receipt of the data may then calculate and display 2735 the gross earnings for each of the displayed pay periods. The calculation of gross earnings may include use of values in fields in the system indicative of state specific rules, such as rules as to maximum amount of overtime, maximum wage rates used for calculation of workers compensation benefits, and other rules. Thus, the calculation of gross earnings for a given pay period may be based on a simple multiplication of hours by hourly rate or may be based on more involved calculations and/or Machine Learning (“ML”) algorithms.

The system then continues to determine and display 2740 average weekly wage data. The determination of average weekly wage may be based on a formula, such as a sum of gross earnings, divided by a number of days worked, then multiplied by a factor, such as 260 (for 5-day work week) or 300 (for a 6-day work week).

The system may cause to display 2745 on the user interface a user option to generate a state form. The state form may be formatted in accordance with state requirements and include required data such as determined average weekly wage, pay periods, gross earnings, employer data, injured worker data, and other data. The formatting may be provided in accordance with stored instructions, which may be embodied in spreadsheet tables. The system may receive 2750 a user request to generate a state form formatted in accordance with requirements of a particular state and populated with data relating to a particular injured worker, and then generate 2755 a suitable printable electronic file, in a suitable format such as Portable Document Format (“PDF”), for printing.

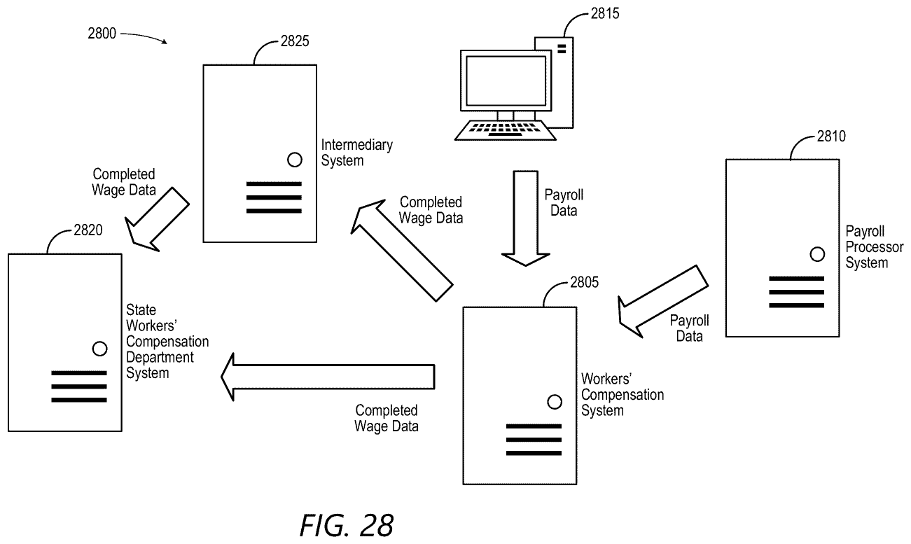

Referring now to FIG. 28, an environment 2800 in which a computer system according to an embodiment is in communication with other systems. Computer system 2805 is configured to receive payroll data from sources such as third-party payroll processor system 2810 and employer computer system 2815. Computer system 2805 uses payroll data to perform determinations of average weekly wage, complete forms and other determinations and processes described here. In these embodiments, computer system 2805 may execute instructions to access received data files. Computer system 2805 furnishes data indicative of average weekly wage, completed state forms, wage and related data, and the like, directly to state workers compensation department computer system 2820. In embodiments, the data may be furnished via a third party such as agent or intermediary computer system 2825.

Data communication may be by periodic upload, e.g., via a tool installed on an employer or payroll processor computer system that accesses relevant data from local databases or data tables stored by payroll processing software such as QUICKBOOKS® or ADP® and provides the data to system 2805. Advantageously, such a tool may be implemented in small file size, saving memory resources at the employer or payroll processing system. It will be appreciated that a tool that performs processes of data extraction has lower memory requirements than a tool that performs more extensive processing. In embodiments, data may be distributed via File Transfer Protocol (“FTP”).

In embodiments, the functionality of computer system 2805 may be implemented in whole or in part by one or more of third-party payroll processor system 2810, employer computer system 2815, and intermediary computer system 2825. For example, suitable spreadsheet tables and web portal data may be distributed and stored on one or more such systems and configured to perform processing at the employer, third-party payroll processor, or intermediary computer system site.

Thus, some embodiments may provide improved benefit calculations and reduce financial inaccuracies (and associated penalties, including accrued interest). In addition, the electronic wage statement files may be transparent and limit areas of confusion for auditors.

Further, some embodiments have been described herein as being used to facilitate workers' compensation benefits. Note, however, that the techniques described herein might be used in connection with other types of benefits. For example, AWW rates might be associated with temporary total disability payments and/or other types of supplemental insurance products and services.

A system for communication with employers, employees, claim handlers and others may include a printing system with a plurality of printers for printing documents including determinations of AWW and associated data, such as employer data, employee data, relevant dates, and other data. Systems for printing, folding, envelope stuffing and application of postage using automated postage meters may be employed, supplied by NEOPOST® or other vendors.

In other embodiments, one or more public cloud, private cloud, hybrid cloud and cloud-like networks may also be implemented, for example, to handle and conduct processing of one or more transactions or processing of the present invention. Cloud based computing may be used herein to handle any one or more of the application, storage and connectivity requirements of the present invention. For example, one or more private clouds may be implemented to handle generation of user interfaces to prompt for employer data, injured worker data, claim data and wage data, and perform determinations of user interface displays and reflexive questions for display, as well as calculation of gross weekly wages and average weekly wages, and related data processing requirements. Furthermore, any suitable data and communication protocols may be employed to accomplish the teachings of the present invention.

Advantageously, the present system may be implemented in a client server or application service provider environment. As a result of the compact file size and related data storage requirements associated with embodiments, such as the spreadsheet table embodiment, lower data storage requirements are achieved using the disclosed embodiments than embodiments in which a standalone program is provided, and thus advantages are achieved as to storage in client server, application service provider and cloud-based embodiments.

Thus, when a workers' compensation claim is filed and the claimant is missing time from work due to an injury, embodiments may help the employer submit wages to an insurer so that accurate benefits can be provided. Each state's regulatory requirements are different and very nuanced, and embodiments may help employers correctly complete the required wage statement forms and for insurance adjusters to accurately calculate the wages and benefit rates. Inaccurate wage statements and inaccurate benefit payments can result in regulatory fines, penalties, and interest charges.

Embodiments create a digital user experience interface that provides a set of dynamic, reflexive branching questions based on state requirements (making it easier for the employer to complete and submit an accurate wage statement). Embodiments may be coded with specific algorithms to derive the accurate wage calculation based on the information provided via the interface. This can then be ingested into a claim system and automatically presented to a claim adjuster, thereby improving the accuracy of benefit payments.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A system for an electronic wage statement file associated with an injury, comprising:
an input device to receive wage statement information via a web portal, including a jurisdiction associated with the injury;
a computer processor for executing program instructions; and
a memory, coupled to the computer processor, for storing program instructions for execution by the computer processor for:
ingesting third-party data associated with an insured from a remote server,
receiving from a party associated with the insured an indication of a pay period frequency via the web portal,
receiving from the party associated with the insured an indication of an initial pay period begin date via the web portal,
automatically pre-populating a series of pay period begin date and pay period end date fields based on the jurisdiction associated with the injury, the third-party data, the pay period frequency, and the initial pay period begin date,
receiving, from the party associated with the insured, information about wage values associated with a plurality of the pay period begin date and pay period end date fields, and
generating the electronic wage statement file based on the received information about wage values.

2. The system of claim 1, wherein the wage values received from the insured include at least one of: (i) a number of regular hours worked, (ii) a number of overtime hours worked, (iii) an hourly rate, and (iv) other wages.

3. The system of claim 2, wherein the memory further stores program instructions for execution by the computer processor for:
automatically computing an average weekly wage amount for the electronic wage statement file.

4. The system of claim 3, wherein the computation of the average weekly wage amount is performed in accordance with a workers' compensation rule engine.

5. The system of claim 4, wherein the electronic wage statement file is associated with one of a plurality of potential jurisdictions and the workers' compensation rule engine computes the average weekly wage amount based on at least one of a minimum value and a maximum value applicable to that jurisdiction.

6. The system of claim 4, wherein a wage increase is automatically and retroactively applied to prior pay periods in accordance with appropriate jurisdiction logic.

7. The system of claim 1, wherein the memory further stores program instructions for execution by the computer processor for:
automatically performing an error check on the wage statement information received from the insured in accordance with a pre-determined error checking rule.

8. The system of claim 1, wherein the memory further stores program instructions for execution by the computer processor for:
dynamically determining and displaying supplemental data based on wage statement information received from the insured.

9. The system of claim 1, wherein the wage statement information received from the insured further includes at least one of: (i) an employee name, (ii) a claim number, (iii) a date of loss, (iv) a date of hire, (v) period of employment information, and (vi) date of completion information.

10. The system of claim 1, wherein the memory further stores program instructions for execution by the computer processor for:
receiving a password from a claim handler, and
validating the password.

11. The system of claim 10, wherein the memory further stores program instructions for execution by the computer processor for:
subsequent to validating the password, receiving from the claim hander indications of exclusion for a sub-set of the plurality of pay period begin date and pay period end date fields, and
re-calculating an average weekly wage based on the indications of exclusion.

12. The system of claim 10, wherein the memory further stores program instructions for execution by the computer processor for:
automatically generating an insurance claim file note associated with the electronic wage statement file including information about a proposed benefit rate calculation.

13. A computer-implemented method for an electronic wage statement file associated with an injury, comprising:
receiving wage statement information via a web portal, including a jurisdiction associated with the injury;
ingesting, by a computer processor, third-party data associated with an insured from a remote server;
receiving from the insured an indication of a pay period frequency via the web portal;
receiving from the insured an indication of an initial pay period begin date via the web portal;
automatically pre-populating by the computer processor a series of pay period begin date and pay period end date fields based on the jurisdiction associated with the injury, the third-party data, the pay period frequency, and initial pay period begin date;
receiving from the insured wage values associated with a plurality of the pay period begin date and pay period end date fields;
automatically generating by the computer processor the electronic wage statement file based on the received wage values; and
storing the electronic wage statement file in a data storage device.

14. The method of claim 13, wherein the wage values received from the insured include all of: (i) a number of regular hours worked, (ii) a number of overtime hours worked, (iii) an hourly rate, and (iv) other wages.

15. The method of claim 13, further comprising:
automatically performing an error check on the wage statement information received from the insured in accordance with a pre-determined error checking rule.

16. The method of claim 13, further comprising:
dynamically determining and displaying supplemental questions and associated answer input fields based on wage statement information received from the insured.

17. The method of claim 13, further comprising:
receiving a password from a claim handler;
validating the password;
subsequent to validating the password, receiving from the claim hander indications of exclusion for a sub-set of the plurality of pay period begin date and pay period end date fields; and
re-calculating an average weekly wage based on the indications of exclusion.

18. A non-transitory computer-readable medium storing instructions adapted to be executed by a computer processor to perform a method for an electronic wage statement file associated with an injury, the method comprising:
receiving wage statement information via a web portal, including a jurisdiction associated with the injury;
ingesting, by the computer processor, third-party data associated with an insured from a remote server;
receiving from the insured an indication of a pay period frequency via the web portal;
receiving from the insured an indication of an initial pay period begin date via the web portal;
automatically pre-populating by the computer processor a series of pay period begin date and pay period end date fields based on the jurisdiction associated with the injury, the third-party data, the pay period frequency, and initial pay period begin date;
receiving from the insured wage values associated with a plurality of the pay period begin date and pay period end date fields;
automatically generating by the computer processor the electronic wage statement file based on the received wage values; and
storing the electronic wage statement file in a data storage device.

19. The medium of claim 18, wherein the wage values received from the insured include all of: (i) a number of regular hours worked, (ii) a number of overtime hours worked, (iii) an hourly rate, and (iv) other wages.

20. The medium of claim 19, further comprising:
automatically performing an error check on the wage statement information received from the insured in accordance with a pre-determined error checking rule.
